(19) United States
(12) Patent Application Publication
(10) Pub. No.: US 2025/0264658 A1
(43) Pub. Date: Aug. 21, 2025

(54) MULTI-WAVELENGTH POLARIZATION DIVERSIFIED OPTICAL RECEIVER CONFIGURATION

(71) Applicant: XILINX, INC., San Jose, CA (US)

(72) Inventors: Zakriya MOHAMMED, San Jose, CA (US); Anish JOSHI, San Jose, CA (US); Chuan XIE, Fremont, CA (US); Gareeyasee SAHA, San Jose, CA (US); Mayank RAJ, San Jose, CA (US); Parag UPADHYAYA, Los Gatos, CA (US); Yohan FRANS, Palo Alto, CA (US)

(21) Appl. No.: 18/443,243

(22) Filed: Feb. 15, 2024

(51) Int. Cl. G02B 6/12; G02B 6/126; H04J 14/02

(52) U.S. Cl. CPC G02B 6/12004; G02B 6/126; H04J 14/0305

(57) ABSTRACT

Examples herein describe optical receiver circuitry. The optical receiver circuitry includes a polarization diversifier and first and second waveguides. The polarization diversifier is configured to receive in input optical signal, output a first component of the input optical signal into a first end of an optical path, and output a second component of the input optical signal into a second end of the optical path. An add-drop ring resonator filter is disposed in the optical path. The first waveguide is configured to transmit the first optical component from the add-drop ring resonator filter to a photodetector circuit. The second waveguide is configured to transmit the second optical component from the add-drop ring resonator filter to the photodetector circuit. The first waveguide has a first length and the second waveguide has a second length that is greater than the first length.

### TECHNICAL FIELD

Examples of the present disclosure generally relate to wavelength division multiplexing (WDM), and more specifically, to optical receiver circuitry.

### BACKGROUND

Wavelength division multiplexing (WDM) is technique for simultaneously transmitting multiple different data streams using an optical fiber by dividing the optical spectrum into different wavelength channels. A transmitter of a WDM system multiplexes the data streams onto the wavelength channels which each operate at a particular wavelength. The multiplexed data streams are transmitted via the optical fiber to a receiver of the WDM system. The receiver includes a demultiplexer which separates the wavelength channels for detection based on the particular wavelengths.

For WDM systems implemented using silicon photonics (SiPh), polarization dependence is a significant challenge because of the relatively high index contrasts and non-symmetric cross-sections associated with these systems. Adverse effects of polarization dependence include mode dispersion where different polarization modes of light travel at different speeds which causes signal distortion. Successful efforts aimed at achieving efficient polarization-insensitive operation for SiPh-based WDM systems have been limited to systems operating at relatively low modulation rates (e.g., below 25 Gbps).

### SUMMARY

Optical receiver circuitry is described in some embodiments. The optical receiver circuitry includes a polarization diversifier, an add-drop ring resonator filter, a photodetector circuit, a first waveguide, and a second waveguide. In various embodiments, the polarization diversifier is configured to receive an input optical signal, output a first component of the input optical signal into a first end of an optical path, and output a second component of the input optical signal into a second end of the optical path. For example, the add-drop ring resonator filter is disposed in the optical path, and the first waveguide is configured to transmit the first component from the add-drop ring resonator filter to the photodetector circuit. The second waveguide is configured to transmit the second component from the add-drop ring resonator filter to the photodetector circuit. In various embodiments, the first waveguide has a first length and the second waveguide has a second length that is greater than the first length.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates optical receiver circuitry in a first example configuration, according to some embodiments.

FIG. 2 illustrates optical receiver circuitry in a second example configuration, according to some embodiments.

FIG. 3 illustrates optical receiver circuitry in a third example configuration, according to some embodiments.

FIG. 4 is a flow diagram depicting a method for receiving an input optical signal by a wavelength division multiplexing (WDM) receiver, according to some embodiments.

FIG. 5 illustrates a representation of electrical eye diagrams, according to some embodiments.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Silicon photonics (SiPh) is a desirable candidate for use in wavelength division multiplexing (WDM) receiver applications due to its compatibility with CMOS, relatively low productions costs, and capacity for large-scale integration. However, SiPh devices are inherently polarization dependent because of relatively high index contrasts and non-symmetric cross-sections associated with these devices. The polarization dependence causes signal distortion which is particularly significant when operating at relatively high modulation rates (e.g., over 25 Gbps).

Examples herein describe optical receiver circuitry. In some embodiments, the optical receiver circuitry includes a polarization diversifier, an add-drop ring resonator filter, a photodetector circuit, a first waveguide, and a second waveguide. In various embodiments, the polarization diversifier is configured to receive an input optical signal (e.g., from a WDM transmitter), output a first component of the input optical signal (e.g., a quasi-transverse-electric mode) into a first end of an optical path, and output a second component of the input optical signal (e.g., a quasi-transverse-magnetic mode) into a second end of the optical path. For example, the polarization diversifier includes a polarization splitter and rotator, a polarization splitting grating coupler, etc.

In one or more embodiments, the add-drop ring resonator filter is disposed in the optical path and configured to receive light from the first and second components having a particular frequency from the optical path. In some examples, the first waveguide transmits the light from the first component having the particular frequency from the add-drop ring resonator filter to the photodetector circuit. In certain embodiments, the second waveguide transmits the light from the second component having the particular frequency from the add-drop ring resonator filter to the photodetector circuit.

In various embodiments, the first waveguide has a first length and the second waveguide has a second length that is greater than the first length. In one or more examples, the first and second lengths are configured for delay matching the first and second components such that the light from the first component having the particular frequency reaches the photodetector circuit at the same time that the light from the second component having the particular frequency reaches the photodetector circuit. By delay matching the first component and the second component of the input optical signal in this way, polarization-insensitive operation is achieved without signal distortion even when operating at relatively high modulation rates (e.g., over 25 Gbps). Moreover, in some examples, a substantial portion of the delay matching may be performed in the optical path such that a difference between the second length and the first length can be minimized to reduce a footprint of the optical receiver circuitry.

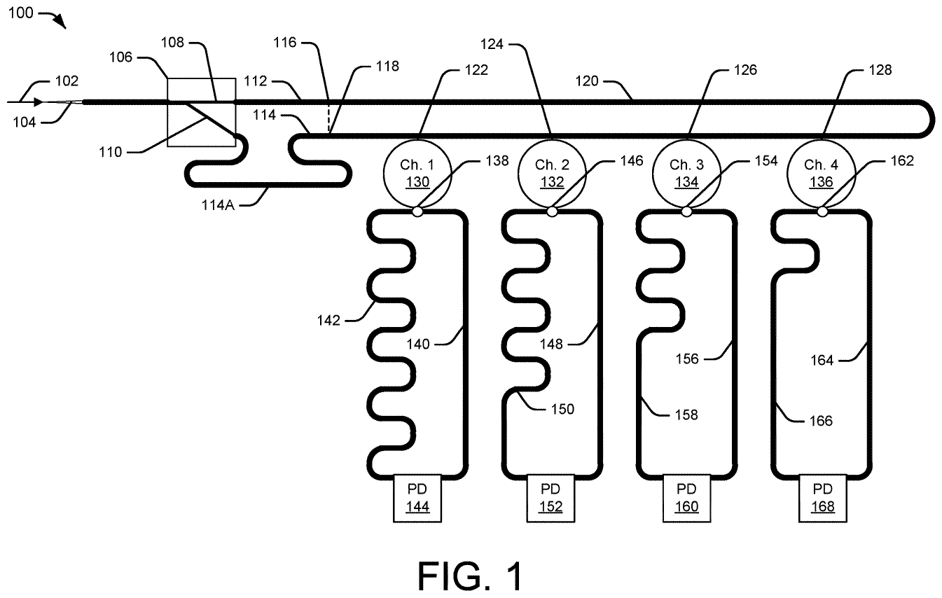

FIG. 1 illustrates optical receiver circuitry in a first example configuration 100, according to some embodiments. In the first example configuration 100, an input optical signal 102 is received, for example, from a transmitter of a wavelength division multiplexing (WDM) system. In various embodiments, an edge coupler 104 such as a nano-tapered edge coupler is utilized to efficiently couple a relatively small waveguide core used to transmit the input optical signal 102 to a larger optical mode. In some examples, the input optical signal 102 generally includes horizontally polarized and vertically polarized components, and the edge coupler 104 couples the horizontally polarized and the vertically polarized components from the relatively small waveguide into quasi-transverse-electric (TE) and quasi-transverse-magnetic (TM) modes, respectively, e.g., in a larger waveguide.

In one or more embodiments, the TE mode and the TM mode are orthogonal, and a polarization diversifier 106 separates the TE mode into a first path 108 and the TM mode into a second path 110. For example, the polarization diversifier 106 includes a polarization splitter and rotator, a polarization splitting grating coupler, etc. The TE mode passes through the first path 108 into a TE path 112. In some embodiments, the polarization diversifier 106 rotates the TM mode by 90 degrees (e.g., into TE polarization) and the rotated TM mode passes through the second path 110 as a TE mode into a TM path 114.

In one or more examples, the polarization diversifier 106 may be associated with an undesirable differential group delay (DGD) which causes light in the TM path 114 to travel faster than light in the TE path 112. For example, the DGD may cause signal degradation. In order to compensate for the DGD, in some examples, a waveguide delay line 114A is added after the polarization diversifier 106 in the TM path 114.

In various embodiments, the waveguide delay line 114A causes light in the TE path 112 to reach point 116 at the same time that light in the TM path 114 reaches point 118. For example, by determining a difference in a velocity of light in the TE path 112 and a velocity of light in the TM path 114, a length of the waveguide delay line 114A is computed such that the light in the TE path 112 and the light in the TM path 114 simultaneously arrive at points the 116, 118, respectively. In some embodiments, the waveguide delay line 114A may be included in the polarization diversifier 106 such that the point 116 is representative of a first end of a looped optical path 120 and the point 118 is representative of a second end of the looped optical path 120.

The looped optical path 120 is illustrated to include points 122, 124, 126, 128 which correspond to locations along the looped optical path 120 of channels associated with different wavelengths of the optical spectrum. In certain embodiments, the point 122 corresponds to a location of channel one 130 which is associated with a first wavelength; the point 124 corresponds to a location of channel two 132 which is associated with a second wavelength; the point 126 corresponds to a location of channel three 134 which is associated with a third wavelength; and the point 128 corresponds to a location of channel four 136 which is associated with a fourth wavelength. Although four channels are illustrated, it is to be appreciated that the first example configuration 100 can include any number of channels.

In some embodiments, channel one 130 includes a first add-drop ring resonator filter disposed in the looped optical path 120. For example, the first add-drop ring resonator filter is configured to selectively remove light having the first wavelength from the looped optical path 120 via one or more add ports, and then transmit the light having the first wavelength out from drop port 138. Since light in the TM path 114 arrives at the point 122 before light from the TE path 112 arrives at the point 122, light from the TE path 112 having the first wavelength is transmitted from the drop port 138 into a first waveguide 140 of channel one 130 and light from the TM path 114 having the first wavelength is transmitted from the drop port 138 into a second waveguide 142 of channel one 130.

In various embodiments, the first waveguide 140 transmits the light from the TE path 112 having the first wavelength to a first photodetector circuit 144. Similarly, in some embodiments, the second waveguide 142 transmits the light from the TM path 114 having the first wavelength to the first photodetector circuit 144. Notably, the first waveguide 140 has a first length and the second waveguide 142 has a second length that is greater than the first length. In one or more examples, the first and second lengths are configured for delay matching the light from the TM path 114 and the light from the TE path 112. For example, the second length is configured to delay the transmission of the light from the TM path 114 having the first wavelength such that the light from the TE path 112 having the first wavelength and the light from the TM path 114 having the first wavelength reach the first photodetector circuit 144 at the same time. In some embodiments, the second length is equal to a velocity of the light from the TM path 114 multiplied by a time required for the light from the TE path 112 to reach the first photodetector circuit 144. In certain embodiments, the first photodetector circuit 144 includes a photodiode configured to detect light having the first wavelength.

In one or more embodiments, channel two 132 includes a second add-drop ring resonator filter disposed in the looped optical path 120. In some examples, the second add-drop ring resonator filter is configured to selectively remove light having the second wavelength from the looped optical path 120 via one or more add ports, and then transmit the light having the second wavelength out from drop port 146. As shown in FIG. 1, light in the TM path 114 arrives at the point 124 before light from the TE path 112 arrives at the point 124. To compensate for the different arrival times at the point 124, light from the TE path 112 having the second wavelength is transmitted from the drop port 146 into a third waveguide 148 of channel two 132 and light from the TM path 114 having the second wavelength is transmitted from the drop port 146 into a fourth waveguide 150 of channel two 132.

In certain embodiments, the third waveguide 148 transmits the light from the TE path 112 having the second wavelength to a second photodetector circuit 152, and the fourth waveguide 150 transmits the light from the TM path 114 having the second wavelength to the second photodetector circuit 152. The third waveguide 148 has a third length and the fourth waveguide 150 has a fourth length that is greater than the third length. In some examples, the third length of the third waveguide 148 may be equal to the first length of the first waveguide 140. In other examples, the third length of the third waveguide 148 can be less than the first length of the first waveguide 140 or greater than the first length of the first waveguide 140.

In various embodiments, the second length of the second waveguide 142 may be greater than the fourth length of the fourth waveguide 150. In these embodiments, the second length is greater than the fourth length because light in the TM path 114 reaches the point 122 before reaching the point 124 and light in the TE path 112 reaches the point 124 before reaching the point 122. In one or more examples, the third and fourth lengths are configured for delay matching the light from the TM path 114 and the light from the TE path 112. In some examples, the fourth length is configured to delay the transmission of the light from the TM path 114 having the second wavelength such that the light from the TE path 112 having the second wavelength and the light from the TM path 114 having the second wavelength reach the second photodetector circuit 152 at the same time. In certain embodiments, the second photodetector circuit 152 includes a photodiode configured to detect light having the second wavelength.

For reasons similar to the reasons articulated with respect to channel one 130 and channel two 132, channel three 134 may include a third add-drop ring resonator filter disposed in the looped optical path 120. In various embodiments, the third add-drop ring resonator filter is configured to selectively remove light having the third wavelength from the looped optical path 120 via one or more add ports, and then transmit the light having the third wavelength out from drop port 154. For example, light from the TE path 112 having the third wavelength is transmitted from the drop port 154 into a fifth waveguide 156 of channel three 134 and light from the TM path 114 having the third wavelength is transmitted from the drop port 154 into a sixth waveguide 158 of channel three 134.

In one or more examples, the fifth waveguide 156 transmits the light from the TE path 112 having the third wavelength to a third photodetector circuit 160 configured to detect light having the third wavelength. For example, the sixth waveguide 158 transmits the light from the TM path 114 having the third wavelength to the third photodetector circuit 160. As shown, the fifth waveguide 156 has a fifth length and the sixth waveguide 158 has a sixth length that is greater than the fifth length. In certain embodiments, the fifth and sixth lengths are configured for delay matching the light from the TM path 114 and the light from the TE path 112 such that the light from the TE path 112 having the third wavelength and the light from the TM path 114 having the third wavelength reach the third photodetector circuit 160 at the same time.

For reasons similar to the reasons articulated with respect to channel one 130 and channel two 132, channel four 136 can include a fourth add-drop ring resonator filter disposed in the looped optical path 120. In one or more embodiments, the fourth add-drop ring resonator filter is configured to selectively remove light having the fourth wavelength from the looped optical path 120 via one or more add ports, and then transmit the light having the fourth wavelength out from drop port 162. In some embodiments, light from the TE path 112 having the fourth wavelength is transmitted from the drop port 162 into a seventh waveguide 164 of channel four 136, and light from the TM path 114 having the fourth wavelength is transmitted from the drop port 162 into an eighth waveguide 166 of channel four 136.

In various embodiments, the seventh waveguide 164 transmits the light from the TE path 112 having the fourth wavelength to a fourth photodetector circuit 168 configured to detect light having the fourth wavelength. The eighth waveguide 166 may transmit the light from the TM path 114 having the fourth wavelength to the fourth photodetector circuit 168. In some examples, the seventh waveguide 164 has a seventh length and the eighth waveguide 166 has an eighth length that is greater than the seventh length. In certain embodiments, the seventh and eighth lengths are configured for delay matching the light from the TM path 114 and the light from the TE path 112 such that the light from the TE path 112 having the fourth wavelength and the light from the TM path 114 having the fourth wavelength reach the fourth photodetector circuit 168 at the same time.

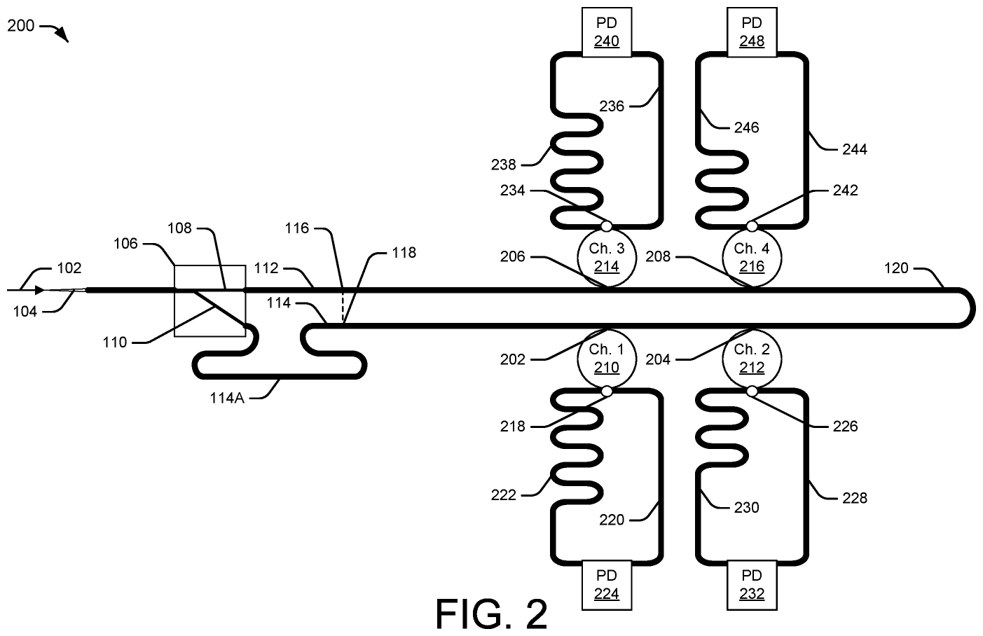

FIG. 2 illustrates optical receiver circuitry in a second example configuration 200, according to some embodiments. In the second example configuration 200, the looped optical path 120 is illustrated to include points 202, 204, 206, 208 which correspond to locations along the looped optical path 120 of channels associated with different wavelengths of the optical spectrum. In some embodiments, the point 202 corresponds to a location of channel one 210 which is associated with a first wavelength; the point 204 corresponds to a location of channel two 212 which is associated with a second wavelength; the point 206 corresponds to a location of channel three 214 which is associated with a third wavelength; and the point 208 corresponds to a location of channel four 216 which is associated with a fourth wavelength. Although four channels are illustrated, it is to be appreciated that the second example configuration 200 can include any number of channels.

Unlike the first example configuration 100 in which the channels 130, 132, 134, 136 are each disposed on the TM path 114 side of the looped optical path 120, in the second example configuration 200 only channel one 210 and channel two 212 are disposed on the TM path 114 side of the looped optical path 120 while channel three 214 and channel four 216 are disposed on the TE path 112 side of the looped optical path 120 in some examples. In the first example configuration 100, the TM path 114 is delayed in each of the channels 130, 132, 134, 136; however, in the second example configuration 200, the TM path 114 is delayed in channel one 210 and in channel two 212 but the TE path 112 is delayed in channel three 214 and in channel four 216.

In some embodiments, channel one 210 includes a first add-drop ring resonator filter disposed in the looped optical path 120. In one or more examples, the first add-drop ring resonator filter is configured to selectively remove light having the first wavelength from the looped optical path 120 via one or more add ports, and then transmit the light having the first wavelength out from drop port 218. Because light in the TM path 114 arrives at the point 202 before light from the TE path 112 arrives at the point 202, light from the TE path 112 having the first wavelength is transmitted from the drop port 218 into a first waveguide 220 of channel one 210 and light from the TM path 114 having the first wavelength is transmitted from the drop port 218 into a second waveguide 222 of channel one 210.

In certain embodiments, the first waveguide 220 transmits the light from the TE path 112 having the first wavelength to a first photodetector circuit 224. Similarly, in some embodiments, the second waveguide 222 transmits the light from the TM path 114 having the first wavelength to the first photodetector circuit 224. As shown in FIG. 2, the first waveguide 220 has a first length and the second waveguide 222 has a second length that is greater than the first length. In some examples, the first and second lengths are configured for delay matching the light from the TM path 114 and the light from the TE path 112. In one or more embodiments, the second length is configured to delay the transmission of the light from the TM path 114 having the first wavelength such that the light from the TE path 112 having the first wavelength and the light from the TM path 114 having the first wavelength reach the first photodetector circuit 224 at the same time. For example, the first photodetector circuit 224 includes a photodiode configured to detect light having the first wavelength.

For reasons similar to the reasons articulated with respect to channel one 210, channel two 212 includes a second add-drop ring resonator filter disposed in the looped optical path 120. The second add-drop ring resonator filter may be configured to selectively remove light having the second wavelength from the looped optical path 120 via one or more add ports, and then transmit the light having the second wavelength out from drop port 226. In various embodiments, light from the TE path 112 having the second wavelength is transmitted from the drop port 226 into a third waveguide 228, and light from the TM path 114 having the second wavelength is transmitted from the drop port 226 into a fourth waveguide 230.

For example, the third waveguide 228 transmits the light from the TE path 112 having the second wavelength to a second photodetector circuit 232, and the third waveguide 228 has a third length. In some embodiments, the fourth waveguide 230 transmits the light from the TM path 114 having the second wavelength to the second photodetector circuit 232, and the fourth waveguide 230 has a fourth length that is greater than the third length. In one or more embodiments, the third and fourth lengths are configured for delay matching the light from the TM path 114 and the light from the TE path 112 such that the light from the TE path 112 having the second wavelength and the light from the TM path 114 having the second wavelength reach the second photodetector circuit 232 at the same time. In various examples, the second photodetector circuit 232 includes at least one photodiode configured to detect light having the second wavelength.

In certain embodiments, channel three 214 includes a third add-drop ring resonator filter disposed in the looped optical path 120, e.g., on the TE path 112 side of the looped optical path 120. In one or more examples, the third add-drop ring resonator filter is configured to selectively remove light having the third wavelength from the looped optical path 120 via one or more add ports, and then transmit the light having the third wavelength out from drop port 234. In the example illustrated in FIG. 2, light in the TE path 112 reaches the point 206 before light in the TM path 114 reaches the point 206. In order to compensate for the different arrival times at the point 206 by the light in the TE path 112 and the light in the TM path 114, light from the TM path 114 having the third wavelength is transmitted from the drop port 234 into a fifth waveguide 236 of channel three 214 and light from the TE path 112 having the third wavelength is transmitted from the drop port 234 into a sixth waveguide 238 of channel three 214.

In some embodiments, the fifth waveguide 236 transmits the light from the TM path 114 having the third wavelength to a third photodetector circuit 240. In these embodiments, the sixth waveguide 238 transmits the light from the TE path 112 having the third wavelength to the third photodetector circuit 240. In various embodiments, the fifth waveguide 236 has a fifth length and the sixth waveguide 238 has a sixth length that is greater than the fifth length. In some embodiments, the sixth length of the sixth waveguide 238 may be the same as the second length of the second waveguide 222. In other embodiments, the sixth length can be different from the second length.

For example, the fifth and sixth lengths are configured for delay matching the light from the TM path 114 and the light from the TE path 112. In one or more embodiments, the sixth length is configured to delay the transmission of the light from the TE path 112 having the third wavelength such that the light from the TM path 114 having the third wavelength and the light from the TE path 112 having the third wavelength reach the third photodetector circuit 240 at the same time. In various embodiments, the third photodetector circuit 240 includes a photodiode configured to detect light having the first wavelength.

For reasons similar to the reasons articulated with respect to channel three 214, channel four 216 includes a fourth add-drop ring resonator filter disposed in the looped optical path 120. For example, the fourth add-drop ring resonator filter may be configured to selectively remove light having the fourth wavelength from the looped optical path 120 via one or more add ports, and then transmit the light having the fourth wavelength out from drop port 242. In various embodiments, light from the TM path 114 having the fourth wavelength is transmitted from the drop port 242 into a seventh waveguide 244, and light from the TE path 112 having the fourth wavelength is transmitted from the drop port 242 into an eighth waveguide 246.

In some embodiments, the seventh waveguide 244 transmits the light from the TM path 114 having the fourth wavelength to a fourth photodetector circuit 248, and the seventh waveguide 244 has a seventh length. In various examples, the eighth waveguide 246 transmits the light from the TE path 112 having the fourth wavelength to the fourth photodetector circuit 248, and the eighth waveguide 246 has an eighth length that is greater than the seventh length. In some embodiments, the eighth length of the eighth waveguide 246 may be the same as the fourth length of the fourth waveguide 230. In other embodiments, the eighth length can be different from the fourth length.

In one or more embodiments, the seventh and eighth lengths are configured for delay matching the light from the TM path 114 and the light from the TE path 112. In some examples, by delay matching the light from the TM path 114 and the light from the TE path 112, the light from the TM path 114 having the fourth wavelength and the light from the TE path 112 having the fourth wavelength reach the fourth photodetector circuit 248 at the same time. In various examples, the fourth photodetector circuit 248 includes at least one photodiode configured to detect light having the fourth wavelength.

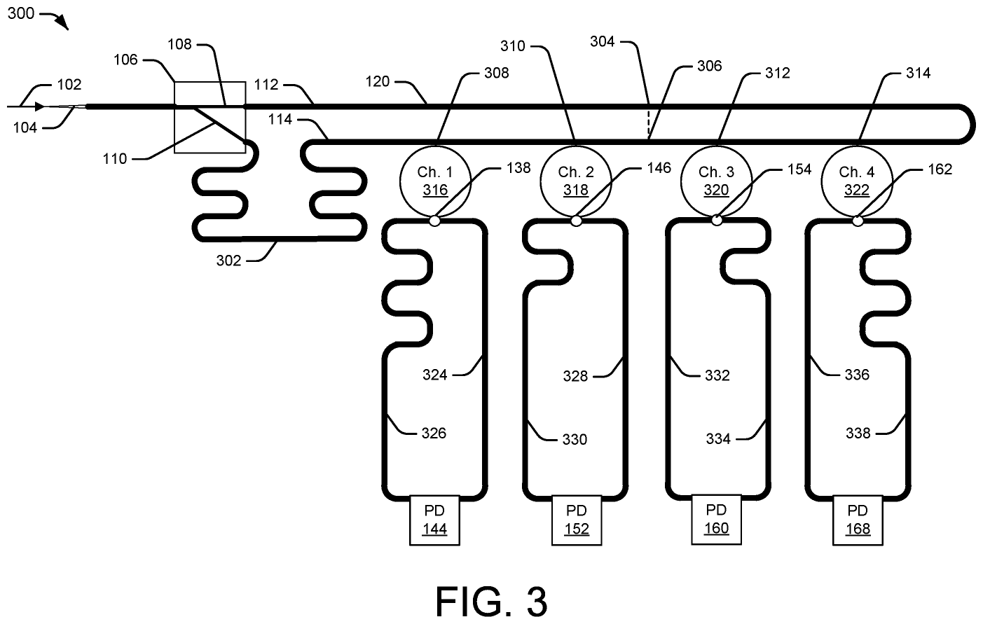

FIG. 3 illustrates optical receiver circuitry in a third example configuration 300, according to some embodiments. As shown, the third example configuration 300 includes an extended waveguide delay line 302 in place of the waveguide delay line 114A illustrated in FIG. 1 and FIG. 2. In some embodiments, the extended waveguide delay line 302 shifts a location in the looped optical path 120 where the light in the TE path 112 and the light in the TM path 114 arrive at the same time from the points 116, 118 (illustrated in FIG. 1 and FIG. 2) to points 304, 306 depicted in FIG. 3. In some examples, by including the extended waveguide delay line 302 and shifting the simultaneous arrival of the light in the TE path 112 and the light in the TM path 114 to the points 304, 306 waveguide lengths for delay matching are substantially reduced relative to waveguide lengths for delay matching in the first example configuration 100.

In the third example configuration 300, the looped optical path 120 is illustrated to include points 308, 310, 312, 314 which correspond to locations along the looped optical path 120 of channels associated with different wavelengths of the optical spectrum. In one or more embodiments, the point 308 corresponds to a location of channel one 316 which is associated with a first wavelength; the point 310 corresponds to a location of channel two 318 which is associated with a second wavelength; the point 312 corresponds to a location of channel three 320 which is associated with a third wavelength; and the point 314 corresponds to a location of channel four 322 which is associated with a fourth wavelength. Although four channels are illustrated, it is to be appreciated that the third example configuration 300 can include any number of channels.

In some embodiments, channel one 316 includes the first add-drop ring resonator filter and the first photodetector circuit 144 described with respect to the first example configuration 100. In various embodiments, light from the TE path 112 having the first wavelength is transmitted from the drop port 138 to the first photodetector circuit 144 by a first waveguide 324 having a first length. In one or more embodiments, light from the TM path 114 having the first wavelength is transmitted from the drop port 138 to the first photodetector circuit 144 by a second waveguide 326 having a second length. For example, the second length is greater than the first length. In some examples, the first and second lengths are configured for delay matching the light from the TE path 112 and the light from the TM path 114 such that the light from the TE path 112 having the first wavelength and the light from the TM path 114 having the first wavelength reach the first photodetector circuit 144 at the same time.

In certain embodiments, channel two 318 includes the second add-drop ring resonator filter and the second photodetector circuit 152 described with respect to the first example configuration 100. In some examples, light from the TE path 112 having the second wavelength is transmitted from the drop port 146 to the second photodetector circuit 152 by a third waveguide 328 having a third length. In one or more embodiments, light from the TM path 114 having the second wavelength is transmitted from the drop port 146 to the second photodetector circuit 152 by a fourth waveguide 330 having a fourth length. The fourth length may be greater than the third length. In various embodiments, the third and fourth lengths are configured for delay matching the light from the TE path 112 and the light from the TM path 114 such that the light from the TE path 112 having the second wavelength and the light from the TM path 114 having the second wavelength reach the second photodetector circuit 152 at the same time.

In one or more embodiments, channel three 320 includes the third add-drop ring resonator filter and the third photodetector circuit 160 described with respect to the first example configuration 100. In various examples, light from the TM path 114 having the third wavelength is transmitted from the drop port 154 to the third photodetector circuit 160 by a fifth waveguide 332 having a fifth length. In certain embodiments, light from the TE path 112 having the third wavelength is transmitted from the drop port 154 to the third photodetector circuit 160 by a sixth waveguide 334 having a sixth length. For example, the sixth length is greater than the fifth length. In some embodiments, the sixth length of the sixth waveguide 334 is the same as the fourth length of the fourth waveguide 330. In other embodiments, the sixth length is different from the fourth length. In some examples, the fifth and sixth lengths are configured for delay matching the light from the TM path 114 and the light from the TE path 112 such that the light from the TM path 114 having the third wavelength and the light from the TE path 112 having the third wavelength reach the third photodetector circuit 160 at the same time.

In some embodiments, channel four 322 includes the fourth add-drop ring resonator filter and the fourth photodetector circuit 168 described with respect to the first example configuration 100. In various examples, light from the TM path 114 having the fourth wavelength is transmitted from the drop port 162 to the fourth photodetector circuit 168 by a seventh waveguide 336 having a seventh length. In certain embodiments, light from the TE path 112 having the fourth wavelength is transmitted from the drop port 162 to the fourth photodetector circuit 168 by an eighth waveguide 338 having an eighth length. The eighth length can be greater than the seventh length. In some embodiments, the eighth length of the eighth waveguide 338 is the same as the second length of the second waveguide 326. In other embodiments, the eighth length is different from the second length. In various embodiments, the seventh and eighth lengths are configured for delay matching the light from the TM path 114 and the light from the TE path 112 such that the light from the TM path 114 having the fourth wavelength and the light from the TE path 112 having the fourth wavelength reach the fourth photodetector circuit 168 at the same time.

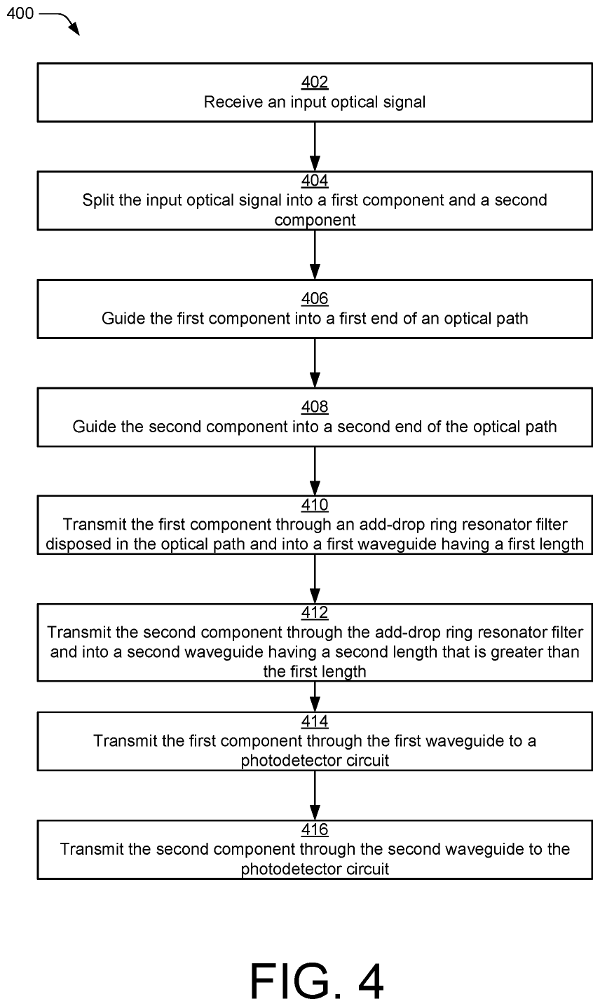

FIG. 4 is a flow diagram depicting a method 400 for receiving an input optical signal by a wavelength division multiplexing (WDM) receiver, according to some embodiments. At 402, an input optical signal is received. In one or more embodiments, the input optical signal 102 is received from a WDM transmitter. At 404, the input optical signal is split into a first component and a second component. In some embodiments, the polarization diversifier 106 splits the quasi-transverse-electric (TE) mode of the input optical signal 102 into the first path 108 and the quasi-transverse-magnetic (TM) mode of the input optical signal 102 into the second path 110.

At 406, the first component is guided into a first end of an optical path. In various embodiments, the TE mode is guided into the TE path 112 of the looped optical path 120. At 408, the second component is guided into a second end of the optical path. In certain embodiments, the TM mode is guided into the TM path 114 of the looped optical path 120. In some examples, in order to compensate for the differential group delay (DGD) which causes the light in the TM path 114 to travel faster than the light in the TE path 112, the waveguide delay line 114A may be included after the polarization diversifier 106 in the TM path 114. In these examples, the waveguide delay line 114A causes the light in the TM path 114 to reach the point 118 at the same time that the light in the TE path 112 reaches the point 116.

At 410, the first component is transmitted through an add-drop ring resonator filter disposed in the optical path and into a first waveguide having a first length. In some embodiments, light from the TE path 112 having the first frequency is transmitted into one or more add ports of the first add-drop ring resonator filter of channel one 130, and the light from the TE path 112 having the first frequency is transmitted out from the drop port 138 into the first waveguide 140 having the first length. At 412, the second component is transmitted through the add-drop ring resonator filter and into a second waveguide having a second length that is greater than the first length. In one or more embodiments, light from the TM path 114 having the first frequency is transmitted into one or more add ports of the first add-drop ring resonator filter of channel one 130, and the light from the TM path 114 having the first frequency is transmitted out from the drop port 138 into the second waveguide 142 having the second length that is greater than the first length.

At 414, the first component is transmitted through the first waveguide to a photodetector circuit. In various embodiments, the light from the TE path 112 having the first wavelength is transmitted through the first waveguide 140 to the first photodetector circuit 144. At 416, the second component is transmitted through the second waveguide to the photodetector circuit. In certain embodiments, the light from the TM path 114 having the first wavelength is transmitted through the second waveguide 142 to the first photodetector circuit 144.

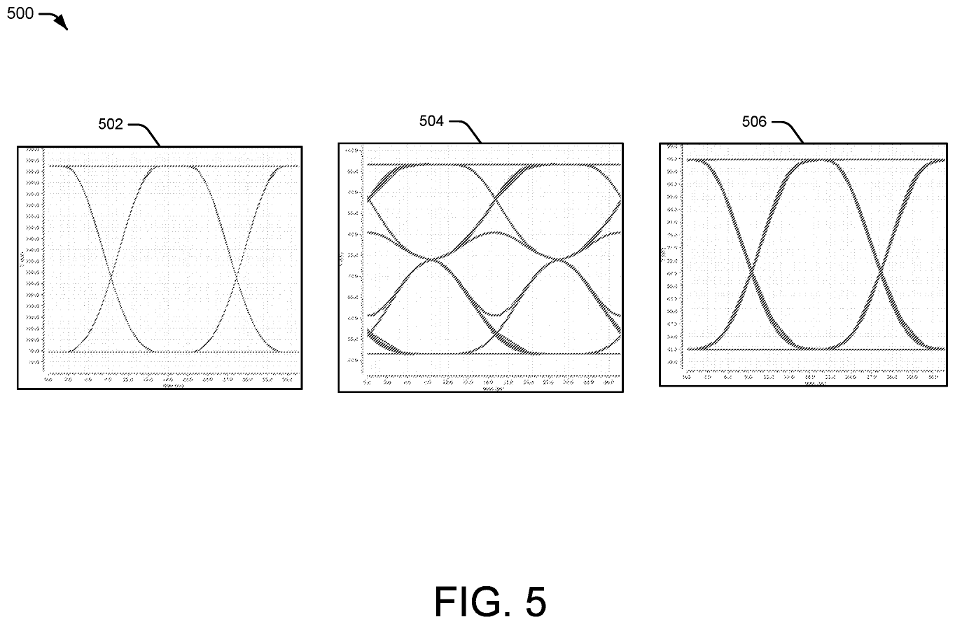

FIG. 5 illustrates a representation 500 of electrical eye diagrams, according to some embodiments. As shown, the representation 500 includes a baseline 502. The representation 500 also includes a first eye diagram 504 for a wavelength division multiplexing (WDM) receiver that does not include delay matching for light from the TE path 112 and light from the TM path 114. The representation 500 additionally includes a second eye diagram 506 for a WDM receiver that includes the described delay matching for light from the TE path 112 and light from the TM path 114. As further shown, the first eye diagram 504 includes significant signal distortion, and the second eye diagram 506 does not include significant signal distortion.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

While the foregoing is directed to specific examples, other and further examples may be devised without departing from the basic scope thereof, and the scope thereof is determined by the claims that follow.

What is claimed is:

1. Optical receiver circuitry comprising:
a polarization diversifier configured to:
receive an input optical signal;
output a first component of the input optical signal into a first end of an optical path; and
output a second component of the input optical signal into a second end of the optical path;
a first add-drop ring resonator filter disposed in the optical path;
a first photodetector circuit;
a first waveguide configured to transmit the first component from the first add-drop ring resonator filter to the first photodetector circuit, the first waveguide having a first length; and
a second waveguide configured to transmit the second component from the first add-drop ring resonator filter to the first photodetector circuit, the second waveguide having a second length that is greater than the first length.

2. The optical receiver circuitry of claim 1, wherein the first component includes a quasi-transverse-electric mode and the second component includes a quasi-transverse-magnetic mode.

3. The optical receiver circuitry of claim 1, wherein the polarization diversifier includes at least one of a polarization splitter and rotator or a polarization splitting grating coupler.

4. The optical receiver circuitry of claim 1, further comprising a waveguide delay line in the optical path.

5. The optical receiver circuitry of claim 1, further comprising:
a second add-drop ring resonator filter disposed in the optical path;
a second photodetector circuit;
a third waveguide configured to transmit the first component from the second add-drop ring resonator filter to the second photodetector circuit; and
a fourth waveguide configured to transmit the second component from the second add-drop ring resonator filter to the second photodetector circuit.

6. The optical receiver circuitry of claim 5, wherein the third waveguide has a third length that is equal to the first length.

7. The optical receiver circuitry of claim 6, wherein the fourth waveguide has a length that is greater than the first length and less than the second length.

8. The optical receiver circuitry of claim 5, wherein the third waveguide has a third length that is equal to the second length.

9. The optical receiver circuitry of claim 8, further comprising a waveguide delay line in the optical path.

10. A wavelength division multiplexing (WDM) receiver comprising:
a polarization diversifier configured to:
receive an input optical signal;
output a first component of the input optical signal into a first end of a looped optical path; and
output a second component of the input optical signal into a second end of the looped optical path;
a first channel extending out from the looped optical path, the first channel comprising:
a first waveguide configured to transmit the first component through the first channel to a first photodetector circuit; and
a second waveguide configured to transmit the second component through the first channel to the first photodetector circuit, the second waveguide including a waveguide delay line; and
a second channel extending out from the looped optical path, the second channel comprising:
a third waveguide configured to transmit the first component through the second channel to a second photodetector circuit; and
a fourth waveguide configured to transmit the second component through the second channel to the second photodetector circuit.

11. The WDM receiver of claim 10, further comprising an add-drop ring resonator filter of the first channel, the first waveguide and the second waveguide coupled to the add-drop ring resonator filter.

12. The WDM receiver of claim 10, wherein the first component includes a quasi-transverse-electric mode and the second component includes a quasi-transverse-magnetic mode.

13. The WDM receiver of claim 10, wherein the polarization diversifier includes at least one of a polarization splitter and rotator or a polarization splitting grating coupler.

14. The WDM receiver of claim 10, further comprising an additional a waveguide delay line included in the looped optical path.

15. The WDM receiver of claim 10, further comprising an additional a waveguide delay line included in the third waveguide.

16. The WDM receiver of claim 10, further comprising an additional a waveguide delay line included in the fourth waveguide.

17. A method comprising:
receiving an input optical signal;
splitting the input optical signal into a first component and a second component;
guiding the first component into a first end of an optical path;
guiding the second component into a second end of the optical path;
transmitting the first component through an add-drop ring resonator filter disposed in the optical path and into a first waveguide having a first length;
transmitting the second component through the add-drop ring resonator filter and into a second waveguide having a second length that is greater than the first length;
transmitting the first component through the first waveguide to a photodetector circuit; and
transmitting the second component through the second waveguide to the photodetector circuit.

18. The method of claim 17, wherein the first component includes a quasi-transverse-electric mode and the second component includes a quasi-transverse-magnetic mode.

19. The method of claim 17, wherein the input optical signal is split into the first component and the second component using a polarization diversifier.

20. The method of claim 17, further comprising delaying transmission of the second component through the optical path.
